(19) United States
(12) Patent Application Publication
(10) Pub. No.: US 2025/0386208 A1
(43) Pub. Date: Dec. 18, 2025

(54) COVERAGE AVAILABILITY VIA NAS SIGNALING

(71) Applicants: THALES DIS FRANCE SAS, Meudon (FR); THALES, Meudon (FR)

(72) Inventors: Jean-Yves FINE, Marseille (FR); Mohamed EL JAAFARI, Toulouse (FR); Dorin PANAITOPOL, La Garenne-Colombes (FR)

(73) Assignees: THALES DIS FRANCE SAS, Meudon (FR); THALES, Meudon (FR)

(21) Appl. No.: 18/879,829

(22) PCT Filed: Jul. 4, 2023
(86) PCT No.: PCT/EP2023/068386

§ 371 Date: Dec. 30, 2024

(30) Foreign Application Priority Data
Jul. 8, 2022 (EP) 22306026.0

(51) Int. Cl. H04W 16/18

(52) U.S. Cl. CPC H04W 16/18

(57) ABSTRACT

The present invention relates to a method for transmitting dynamic coverage availability information between a core network, comprising an access and mobility management function and collaborative with an access network having dynamic coverage, and a user equipment able to connect to the access network, the method comprising the following steps, for the access and mobility management function:
receiving a set of points characterizing anticipated positions of the user equipment,
retrieving dynamic coverage availability information for at least one point belonging to the anticipated positions of the user equipment,
sending to the user equipment a signaling message, in the Non-Access Stratum NAS layer, comprising the retrieved dynamic coverage availability information.

### TECHNICAL FIELD

The invention relates to the field of telecommunications using a 4th generation (4G) and 5th generation (5G) cellular network, as specified by the 3GPP standardization organization, where dynamic network coverage is offered to user equipments.

An application domain relates to satellite communications, in the case of integration of the satellite system into the 4th generation (4G) and 5th generation (5G) cellular network, as specified by the 3GPP standardization organization (Third Generation Partnership Project). Another potential application domain is for V2X communications, e.g. a car that requests information about the discontinuity of the coverage before even taking a given path.

The invention thus relates to a method for transmitting dynamic coverage availability information to a user equipment using an access network defined by standards. The invention also relates to an access and mobility management function, to a core network and to a user equipment for implementing the method.

### PRIOR ART

The invention relates to the 4th generation (4G) and 5th generation (5G) cellular network, as specified by the standardization organization 3GPP, and for example described hereinafter, in the case of integration of the satellite system into the cellular network of 4th generation (4G) and 5th generation (5G), as specified by the standardization organization 3GPP (https://www.3gpp.org/).

As an example, the field of application concerning satellite communications is described hereinafter. A set of satellites, managed by a satellite control center, will provide 4G or 5G mobile telephony coverage and thus serve as an access network, alone or in addition to a terrestrial network, to a core network administered by the mobile telephony operator, which core network will implement the various functions inherent in this network: Security, mobility management, billing, etc

For different reasons, such as for example, the gradual deployment of the constellation of satellites, the constellations, by design, do not allow total coverage of a zone of the Earth, maintenance operations, partial failure of the satellite access system, or other aspects. It is thus possible that a given geographical zone does not benefit from continuous satellite coverage. Such a discontinuity and coverage intermittency, whether recurring or not, will have an impact on the 4G (EPS) or 5G (5GS) telecommunication system.

A user equipment (UE) will have to know the coverage discontinuities in order to switch to sleep mode and to search for the satellite network only if it is present, so as to optimize the lifetime of its battery.

For its own part, the core network should know whether the user equipment is outside of coverage, or conversely within coverage for call management and services.

The 3GPP produces standards defining the needs, architecture, and operation of the mobile communication system. The first normative elements in relation to the satellite system, whether it is geostationary GEO, in low Earth orbit LEO or in medium Earth orbit MEO, have been defined in the “3GPP Release-17” and ongoing standards work, for systems that will be in place in the years to come. The management of the satellite coverage information is an essential point for effective use of satellites in the context of cellular communications. It is in particular necessary for the user equipments to be able to be informed as precisely as possible about the possibility of using satellite coverage.

Two published solutions have been identified to allow the transmission of coverage information to the user equipment.

The first solution consists of satellite broadcast ephemeris services. This is also being standardized, as can be seen in discussions on the 3GPP server during the meeting of the RAN2 group held in May 2022.

Here, it involves adding, in the system information broadcast by the cell, an additional group of information called “assistance data” which will allow the user equipment to extrapolate paths of a certain number of satellites through the broadcasting of the orbital parameters, according to the SGP4 “Simplified General Perturbation” system [Cranford, 1970], in use for the determination of low Earth orbit satellites.

The broadcasting of the ephemerides of certain satellites via the radio broadcast channel however has the following disadvantages. The main drawback is that broadcasting the ephemerides of the satellite ensuring the service and the ephemerides of neighboring satellites is not sufficient to ensure the effective anticipated coverage of a zone. It is not sufficient for a satellite to be in visibility so that a user equipment can connect it. To verify it, it is necessary to know the antenna characteristics, the link budget, the orientation of the beams and their footprint, to integrate maintenance operations and fault and error management.

Also, since this first solution is based on the regeneration of the coverage information by the user equipment from the ephemerides, the information between the user equipment and the core network cannot be unique. In addition, many user equipments do not possess the resources needed to perform such a coverage regeneration function. In particular, this method also requires complex calculations of orbit propagation from the user equipment, which consumes resources.

This is, in any case, not conceivable in a context of optimizing the time window of battery life for connected objects. Furthermore, the permanently broadcasting of these ephemerides risks overloading the control plane of the core network.

The second solution identified proposes a service defining the coverage for a set of points, on the Internet or in the operator network. This service is accessible via http requests by the user equipment. This Solution is described in the document “New Solution for KI #1, KI #2: Provision of Coverage Data to a UE” for the Study Item (SI) FS_5GSAT_Ph 2 for Rel-18 on the 3GPP server during the last meeting of the SA2 group which was held on May 16 to 20, 2022.

Here, it means proposing that the user equipment makes http requests in the user plane to a coverage server on the Internet and obtains in return a series of bitmaps each defining the surrounding coverage for a given instant.

This solution consisting, for the user equipment, of making http requests in the user plane to an Internet server or in the operator network is limited by a communication initiated exclusively by the user equipment, which excludes the ability to send updates of the coverage on the initiative of the network. Also, the protocol used, i.e. http, de facto restricts the solution to user equipments supporting IP (Internet Protocol) and, in any case, this solution requires a dedicated data connection.

Today, there is a need for an efficient and simple solution that allows all user equipments, including constrained user equipments, to access the knowledge of satellite coverage.

### DISCLOSURE OF THE INVENTION

The present invention aims to allow simple, easily installed, efficient communication between user equipment and a service for providing coverage data.

The present invention relates to a method for transmitting dynamic coverage availability information between a core network, comprising an access and mobility management function and collaborative with an access network having dynamic coverage, and a user equipment able to connect to the access network, the method comprising the following steps, for the access and mobility management function:
receiving a set of points characterizing anticipated positions of the user equipment,
retrieving dynamic coverage availability information for at least one point belonging to the anticipated positions of the user equipment,
sending to the user equipment a signaling message, in the Non-Access Stratum NAS layer, comprising the retrieved dynamic coverage availability information.

The invention changes the Non-Access Stratum NAS signaling protocols to keep the user equipment informed of the coverage discontinuities of the access system. The NAS signaling interface is used to transmit predicted information of satellite coverage availability along a trajectory or for a given zone, from the core network to the user equipment.

The invention makes it possible to share detailed information for coverage of the access network, in particular satellite coverage, between the core network and the user equipment. This allows the user equipment to optimize its consumption and access to the 4G or 5G network. On this basis, the user equipment is able to manage calls and services by using the coverage of the access network in an optimal manner.

The invention allows unique, detailed sharing of satellite coverage information between the core network and the user equipment, which allows the user equipment to optimize its consumption and its access. This also allows the 4G and 5G network and the core network to manage calls and services.

The invention uses the Non-Access Stratum NAS layer and thus avoids using the user plane of the core network. The exchange of data is limited to the availability information retrieved by the core network's access and mobility management function, AMF (Access and Mobility Function) in the case of 5G or by the MME (Mobility Management Entity) network function in the case of 4G. A direct consequence is that the collection of availability information is centralized by this access management and mobility function, which ensures complete, reliable information.

The invention is thus based on the essential presence in the core network of an AMF function (Access and Mobility Function for an implementation alternative with a 5G network) or MME (Mobility Management Entity for an implementation alternative with a 4G/LTE core network) which controls the NAS procedure as described in the TS 23.501/23.502 or TS 23.401/23.402/24.301 specifications.

The invention can be deployed on all 4th and 5th generation networks, for example having possible access by a satellite network and which with the aim of integrating the satellite coverage predictions by enlisting a service for providing coverage availability data.

Compared to the broadcasting of the ephemerides of certain satellites via the radio broadcast channel of the first solution of the prior art, the use of NAS signaling to send information relating to the coverage has the advantage of being able to evaluate the effective future coverage of a zone by the core network or by an external entity based not only on ephemerides but also on the antenna characteristics and the link budgets while integrating fault and error management, provided by the various sub-systems in charge. The evaluation of the effective coverage results in the production of the availability information according to the invention.

Thus, the availability information being retrieved by the access and mobility function and then sent to the user equipment, the information between user equipment and core network is unique, and thus the procedures for managing mobility in light of this information are consistent.

Finally, the invention does not require any propagation of orbits/calculation of orbit propagation from the user equipment, which saves the resources, in a context of optimizing the lifetime of the batteries for connected objects.

Compared to an Internet service or a service inserted into the operator network, accessible via http requests by the user equipment, according to the second solution of the prior art, the use of NAS signaling to send satellite coverage information has the advantage of being able to implement transmission according to a request/response mode or else according to a notification mode. Thus, the initiative of the transfer can therefore be at the initiative of the user equipment (request/response mode) or at the initiative of the network (notification mode).

Also, the transmission of availability information according to the invention does not require the allocation of resources in the user plane because no data connection is required with the required invention. This also avoids any corresponding context allocation.

Also, by aggregating the availability data with existing signaling messages also used in the NAS layer. Only new fields in existing NAS protocols are added

Finally, by proposing a standardization of messages, the invention ensures interoperability between user equipments and the core network.

According to an advantageous feature of the invention, the availability information of dynamic coverage comprises events related to dynamic coverage, an event being qualified by an event type, a time stamp (or several timestamps) and coordinates of a point (or of several points) of the anticipated positions of the user equipment.

This feature makes it possible to limit the availability information to events which mark a change of coverage for a given point (or several points) at a given instant (or several instants).

Advantageously, the event type is an absence of coverage or a presence of coverage.

This definition of two event types only makes it possible to simply encode the expected changes in the anticipated positions of the user equipment. This makes it possible to encode this information on a single bit, which is advantageous in terms of signaling and resources. This makes it possible to give a “presence or absence” status on the situation present at the time the service providing availability information is enlisted, and also to report coverage regain or a coverage loss. It is therefore advantageous and sufficient to implement only two event types.

This makes it possible to optimize the amount of data rather than to provide a dot map on all anticipated positions. A “coverage regain” type can be added to distinguish regaining coverage after a coverage gap and a “coverage loss” type to distinguish entering into a coverage gap.

According to an advantageous feature, an oversampling step of the anticipated positions of the user equipment being defined, the dynamic coverage availability information is limited to oversampled points according to the oversampling step.

The set of points received constitutes a first sampling of the zone or trajectory. The use of an oversampling step is useful to adjust the precision of determining the availability of coverage.

Advantageously, a zone type is associated with the set of points characterizing anticipated positions of the user equipment, the zone then defined by the set of points that can be of the trajectory type or of the polygon type or of the polyhedron type within which the user equipment is likely to move.

This makes it possible to refine the knowledge of the possible anticipated positions of the user equipment. For the determination of availability information, it remains possible to consider by default the set of points received with a margin around these points to determine a zone of anticipated positions. However, knowledge of the zone type defined by the points received makes it possible to better characterize the anticipated positions of the user equipment.

The availability information is therefore related to a trajectory or a geographical movement zone, as well as to the oversampling step. A study time window can be predefined and fixed or required and defined at the same time as the elements received by the access management and mobility function are provided.

According to another advantageous feature, the dynamic coverage availability information is retrieved from a service for providing centralized dynamic coverage availability information associated with the core network.

Such a service, collaborating with the satellite management system, can be external to the core network or be integrated into the core network as elsewhere described in European patent application No. 22305714.

Also, according to a preferred embodiment, the service for providing centralized dynamic coverage availability information is integrated into the core network as a network function according to a service architecture.

According to a particular embodiment of the invention, the set of points is received from the user equipment, which is able to determine its position and future positions.

In this embodiment, the user equipment requests coverage information from the core network, using existing and standardized NAS signaling messages, by itself specifying the elements that make it possible to determine the availability information. The core network returns predictions on the exposure of the trajectory or zone, with corresponding locations and dating elements.

According to another particular embodiment, the set of points is received from a management entity of the network having access to the position of the user equipment and to the anticipated positions.

This embodiment may coexist with the previous particular embodiment between a core network and a user equipment. These two embodiments address different situations but can nevertheless be encountered by a user equipment. This embodiment makes it possible to push availability information to a user equipment without the user equipment requesting it on its own. It can thus make it possible to signal coverage information to user equipments that are also passive and that do not have means for determining the anticipated positions, for example. In particular, this makes it possible to address constrained user equipments or emergency situations.

In another particular embodiment, the method comprises steps of:
registering the user equipment with an update service for the dynamic coverage availability information,
automatically sending updated dynamic coverage availability information to the user equipment in a signaling message in the NAS layer.

This embodiment allows the user equipment to be registered with the access and mobility management function of the core network in order to be kept abreast of any changes in the coverage availability information.

Thus, advantageously, updated dynamic coverage availability information is received in a configuration update message as already defined in the NAS protocols.

The invention also relates to an access and mobility management function integrated into a core network collaborating with an access network having dynamic coverage, the access and mobility management function comprising a communication interface configured to communicate with a user equipment able to connect to the access network.

The access and mobility management function being configured to carry out a method according to one of the preceding claims, and in order to do so, configured for:
receiving a set of points characterizing anticipated positions of the user equipment,
retrieving dynamic coverage availability information for at least one point belonging to the anticipated positions of the user equipment,
sending to the user equipment a signaling message, in the NAS layer, comprising the retrieved dynamic coverage availability information.

This access and mobility management function can implement each or several of the advantageous embodiments and features described above.

The invention also relates to a core network comprising such an access management and mobility function.

According to a preferred embodiment, the service for providing dynamic coverage availability information is integrated into the core network as a network function according to a service architecture.

This embodiment corresponds to the invention described and protected in European patent application No. 22305714.

Finally, the invention relates to a user equipment capable of connecting to a function for managing access and mobility of a core network according to the invention via an access network having dynamic coverage, the user equipment further comprising a geolocation device for determining its geographical position, the user equipment being configured for:
receiving, from the access and mobility management function, a signaling message in the NAS layer comprising dynamic coverage availability information,
managing connections to the access network based on the received dynamic coverage availability information and the geographical position of the user equipment.

Advantageously, the user equipment is further configured for:
determining a set of points characterizing anticipated positions of the user equipment,
sending, to the access and mobility management function, a message in the NAS layer including the set of points thus determined to allow it to retrieve the availability information.

Thus, when the user equipment UE sends a NAS signaling message over the 4G or 5G network via satellite or terrestrial access, the user equipment UE associates with the information elements already defined for this message a new information element containing all the anticipated positions {P0, P1, P2, . . . , Pn}, a type for discriminating between several zone definition options such as e.g. trajectory or zone of movement/zone of interest or points of interest, as well as a “step” to give a minimum distance between two points of a trajectory or a polyhedron, as well as advantageously a period of study for which the core network must provide information related to the coverage of the points thus defined by oversampling using the step.

In general, it is noted here that the various features and embodiments/operation can be implemented alone or in combination or juxtaposition with one or the other of the features and embodiments as claimed. One embodiment can therefore be implemented concomitantly with another. This makes it possible in particular to treat different situations depending on the context or need encountered. In particular, it is clear that the two embodiments relating to requesting from or registering with a notification service can be implemented at the same time.

It is also noted here that the claims have been centered on a transmission method having specific features for an AMF/MME access and mobility management function. It goes without saying that any claim of another category, for example aiming at a core network comprising an access and mobility management function with these same features and behaviors is to be considered as described in the present application and can be subsequently claimed as such.

In particular, the access and mobility management function according to the invention may have all the features and behaviors/configurations as claimed for the method and these characteristics and behaviors/configurations may subsequently be claimed in connection with the function.

Thus, in summary, with the invention, the situation is avoided wherein several parameters are broadcast and the user equipment is left to make its own discontinuity prediction, which may not be reliable and is not optimal from the point of view of energy-saving since the user equipment must make computing extrapolations. With the invention, the core network, more precisely its access and mobility management network function (AMF/MME) has access to a service capable of predicting and verifying the future coverage for a user equipment according to parameters defining the zone where the user equipment is located. The NAS layer is used between the user equipment and the network function AMF to provide information on the discontinuity to the user equipment, that information being optimized in terms of data size, not requiring additional a support configuration, and compatible with all 5G UEs.

For the performance of the preceding objectives and related objectives, one or more embodiments comprise the features described below in a complete and detailed manner.

### BRIEF DESCRIPTION OF THE DRAWINGS

The following description and the accompanying drawings illustrate in detail some illustrative aspects and represent only a few of the various ways in which the principles of the invention can be employed. Other advantages and features will become apparent from the following detailed description, when considered in conjunction with the drawings, and the disclosed embodiments are intended to include all these aspects and equivalents thereof.

FIG. 1 schematically shows the protocol architecture of a 5G network, the same concepts are present in 4G;

FIG. 2 schematically shows the constituent elements of a 5G network within which the invention can be implemented;

FIG. 3 describes how the invention fits into the sequence diagram defining the procedure for recording on the NAS layer in the case of 5G access;

FIG. 4 schematically shows the context of the invention; and

FIG. 5 schematically shows an oversampling of a zone defined by a set of points defining the anticipated positions of a user equipment;

FIGS. 6A, 6B and 6C illustrate the operation of the invention in an example application where the anticipated positions of the user equipment are located on a trajectory;

FIG. 7 shows a preferred embodiment of the invention.

### DETAILED DESCRIPTION OF THE FIGURES AND EMBODIMENTS

For a more complete understanding of the invention, this will now be described in detail with reference to the appended figures. The detailed description will illustrate and describe what is considered to be a preferred embodiment of the invention. It is of course understood that various modifications and changes of shape or detail could easily be made without departing from the scope of the invention. It is therefore provided that the invention is not limited to the exact shape and details shown and described herein, nor to anything less than the entirety of the invention disclosed herein and claimed below. The same elements have been designated by the same references in the various drawings. For clarity's sake, only the elements and the steps which are useful to understanding the present invention have been shown in the drawings and will be described.

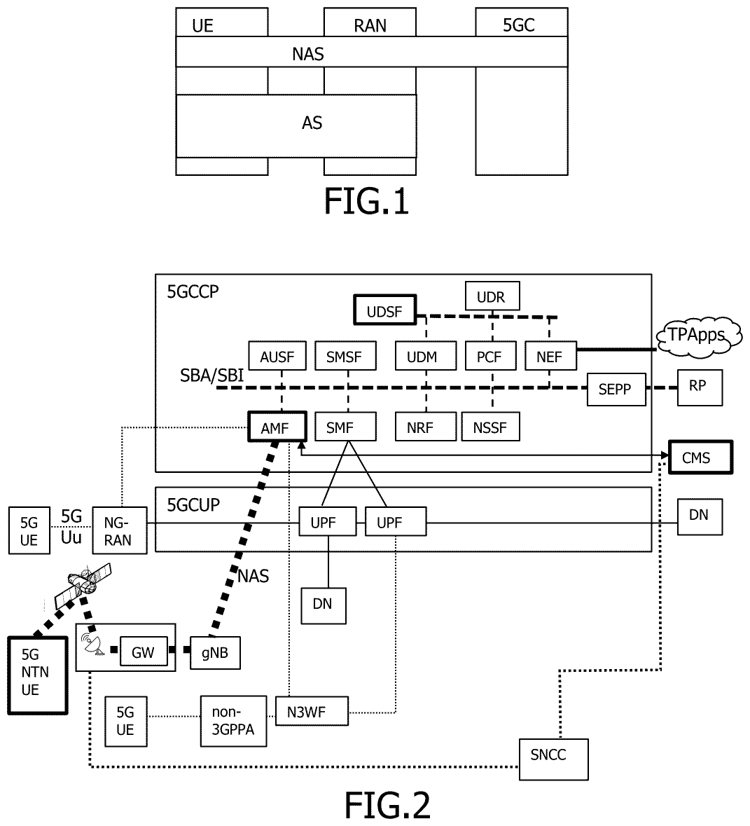

The architecture and procedures inherent in the 5G network are specified in the standards TS 23.501, TS 23.502 “Non-Access-Stratum (NAS) protocol for 5G System (5GS)”. Signals enabling the establishment, session management, mobility and security of exchanges between the core network and the UE is defined in standard TS 24.501. This is shown in FIG. 1 where the various communication layers between a user equipment UE and a core network 5GC are shown via a cellular network (RAN).

The equivalent specifications for 4G are respectively for the architecture and the procedures of the standards TS 23.401, 23.402 and for the signals, TS 24.301 “Non-Access-Stratum (NAS) protocol for Evolved Packet System (EPS)”.

This 4G or 5G signaling layer is called “NAS-Non Access Stratum”, as opposed to the “AS-Access Stratum” layer.

The AS layer makes it possible to establish and manage radio channels between the user equipment and the base station. The radio protocols between the user equipments and the cellular network are established in this layer which, furthermore, carries the information on the cellular network.

The NAS layer is a functional layer normally used to manage the establishment of communication sessions and to maintain continuous communications with the user equipment in mobility. The NAS layer defines, for its part, all of the messages exchanged between the user equipment UE and the core network, the input point of which is the Function of the AMF (“Access and Mobility Management Function”) network for 5G and the MME (Mobility Management Entity) for 4G. It is this NAS signaling that is used according to the invention in an original manner not heretofore known.

The establishment of a PDU session is carried out using the NAS layer.

More specifically, in an exemplary embodiment described below, the invention proposes that the user equipment requests, using existing NAS signaling messages defined in the standards, coverage availability information to the core network. For this purpose, it is advantageously a trajectory or a geographical movement zone, as well as a step and a period of study. The core network returns, according to the invention, its predictions on the exposure of the trajectory or zone, with the corresponding locations and dating elements also using existing NAS signaling messages defined in the standards.

It is also envisaged according to the invention that the core network asynchronously notifies the user equipment of any change in the coverage for the trajectory or the zone.

FIG. 2 shows all the constituent elements of the different subsystems, in the case of a 5G network. This figure is extracted from standard documents where a detailed description is accessible. For the implementation of the invention, it is important to note that, among the constituent elements of the core network 5GC, divided into a user plane 5GCUP and a control plane 5GCCP. The control plane 5GCCP includes a central access and mobility management element called AMF (for “Access Management Function”) in charge of signaling with 5G user equipments UE connectable to a terrestrial network and 5G user equipments NTN UE connectable to a terrestrial network or to a non-terrestrial network. The core network function AMF is the access and mobility management function within the meaning of the invention as defined by the standard. The terms AMF therefore refer hereinafter to the AMF function or its MME equivalent defined in 4G.

A 5G user equipment NTN UE highlighted by a bold line can connect to the core network according to at least two modalities: terrestrial access, typically via a new generation network NG-RAN and a 3GPP satellite access via a dedicated gateway GW. Such a 5G user equipment NTN UE generally also has the possibility of connecting to the core network via non-3GPP terrestrial access, for example via Wi-Fi.

The thick dotted line shows the circulation of messages in the NAS layer as used by the 5GCCP control plane elements as well as by the invention.

For the purposes of the invention, it is necessary for the access and mobility management function AMF to communicate with a CMS (“Coverage Map Server”) service for managing coverage maps capable of providing dynamic coverage information. Thus, in an illustrative embodiment described below, the invention proposes that the user equipment requests, using existing NAS signaling messages defined in the standards, coverage availability information to the core network. For this purpose, it is advantageously a trajectory or a geographical movement zone, as well as a step and a period of study. The core network returns, according to the invention, its predictions on the exposure of the trajectory or zone, with the corresponding locations and dating elements also using existing NAS signaling messages defined in the standards.

It is also envisaged according to the invention that the core network asynchronously notifies the user equipment of any change in the coverage for the trajectory or the zone.

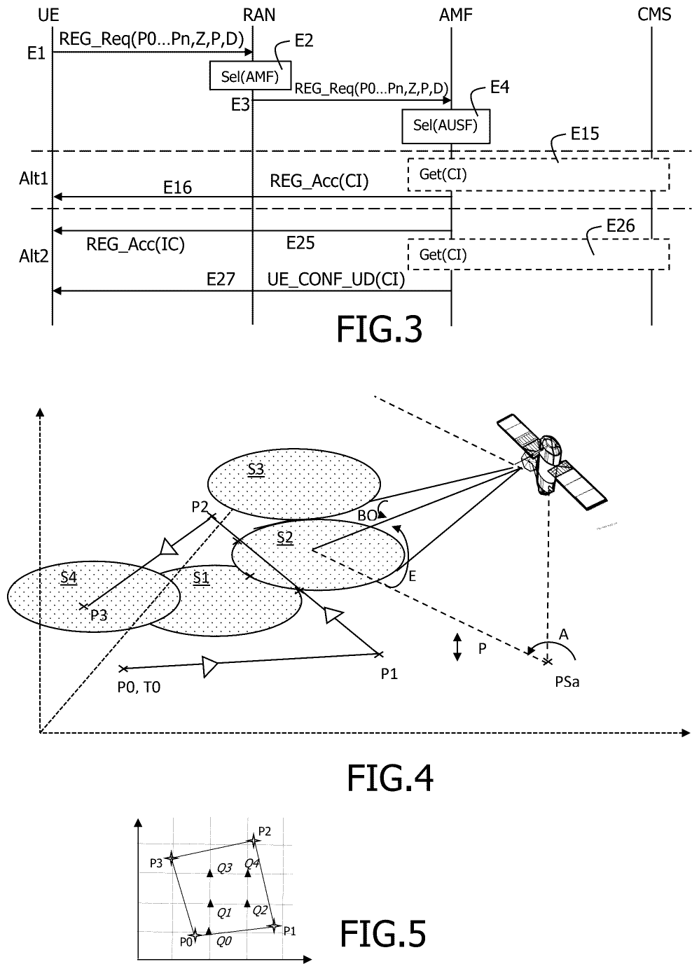

FIG. 3 describes how the invention fits into the sequence diagram defining the procedure for recording on the NAS layer in the case of 5G access implementing a user equipment UE, an access network RAN, an access and mobility management function AMF and a service for providing dynamic coverage availability information CMS, further shown in FIG. 2.

It is noted here that the service for providing availability information can be supported by the network function AMF itself which would then centralize coverage data provided for example by a Satellite Network Control Center (SNCC) and which would itself produce availability information.

For the purposes of illustration, an example of a “REGISTRATION 5G” procedure used to benefit from a service as described in the standard, is here detailed, but other procedures belonging to the NAS protocols such as e.g. “PDU SESSION” in 5G, or e.g. a PDN CONNECTIVITY in 4G, a NAS PDU or other message, could be used for implementing the invention if they are procedures performed in the NAS layer. Details of the registration procedure used in this example are given in the public document: TS 23.502 § 4.2.2 Registration procedures.

In a first step E1, the user equipment UE sends a registration request REG_Req to the access network RAN which selects a serving access and mobility management function AMF in a step E2. The access network RAN then transfers the request to the network function AMF in a step E3. This applies in particular to an initial registration, a periodic registration or a registration update. The registration request REG_Req includes at least one list of points P0 . . . Pn and, advantageously, a zone type Z, a sampling step P, a time window or period of study D.

In the preferred embodiment, the elements provided by the user equipment UE are therefore:
A series of positions {P0, P1, . . . , Pn} defining its current position (P0) and a certain number of waypoints of its anticipated future trajectory. Such a series of points can also determine a movement zone for the user equipment UE. In this case, an information element, i.e. a zone type, defining whether it is a trajectory or a movement zone is then advantageously provided by the user equipment UE. A point (Pi) is defined according to a universal coordinate system which makes it possible to locate it uniquely on the surface of the globe. For example a triplet (Latitude, Longitude, Altitude). This series of points represents a first sampling of the zone.
A “step” P or minimum oversampling distance of the trajectory or zone.
A period D during which the user equipment waits to receive information on the coverage of the trajectory or of the zone.

As shown by step E4, the network function AMF then performs the usual procedures in accordance with TS23.501/23.502 comprising a selection of AUSF for authentication and security, selection of UDM and PCF.

Next, according to a first alternative Alt1, in a step E15, the function of the AMF network, in coordination with a service for providing CMS availability information (“Coverage Map Server”) having knowledge of dynamic coverage maps, the network function AMF determines a list of coverage events for the sampled positions with the sampling step and for an anticipated period of the study time window constituting availability information CI (“Coverage Information”). Details on the determination of the events are given in the rest of the description.

Next, in a step E16, the availability information CI including the list of the coverage events for the sampled positions is sent to the user equipment by the network function AMF in the NAS layer, typically by a registration acceptance message REG_Acc in the first alternative Alt1.

The events are qualified at least according to the invention. This means that at least the coordinates of a sampling point, an absolute time stamp and a coverage event type, loss or regain, to categorize the event. Advantageously, the type of coverage (LEO/MEO/GEO/land) and a cell identification are also included in the availability information CI. This is also detailed hereinafter.

The proposed example uses standardized messages REG_Req requesting registration, “REGISTRATION REQUEST”, and REG_Acc accepting the registration, “REGISTRATION ACCEPTANCE”, to transmit the information necessary to determine/anticipate the coverage discontinuity.

Thus, according to a second alternative Alt2, the network function AMF sends, in a step E25, a message to accept the registration REG_Acc of the user equipment UE outside any transmission of availability data. Next, the access and mobility management function AMF retrieves the availability information CI in a step E26 from the CMS service. Finally, it pushes the availability information CI in a message in the NAS layer as a service. This “push” mode of the availability information CI is advantageously implemented with an update message of the configuration UE_CONF_UD (or UCU) including the availability information CI as shown by step E27.

It is noted here that the NAS message UE_CONF_UD allows for 5G the configuration of the user equipment as specified in the following way in paragraph § 4.2.4 of TS 23.502: “UE configuration may be updated by the network at any time using UE Configuration Update procedure. UE configuration includes: Access and Mobility Management related parameters decided and provided by the AMF.”

As an alternative of operation and implementation, the user equipment UE may also use a session establishment procedure “PDU SESSION ESTABLISHMENT” also as per the standard. It can also use other types of standardized messages like the service request “SERVICE REQUEST” or any other “uplink” message of the NAS type.

It is noted here that, in the case of a 4G network, according to the same principle, the ATTACH network attachment procedure, as well as for example the TRACKING AREA UPDATE procedure, or a (NAS) ATTACH REQUEST/RESPONSE, or PDN CONNECTIVITY REQUEST/RESPONSE, identification procedure (e.g. IDENTITY REQUEST/RESPONSE), authentication procedure (e.g. AUTHENTICATION REQUEST/RESPONSE) or any other bidirectional NAS procedure can be used to carry the exchange of specific information of the invention. For example, the information P0 . . . Pn can also be transported in an (NAS) ATTACH REQUEST, an (NAS) IDENTITY RESPONSE or (NAS) AUTHENTIFICATION RESPONSE.

Thus, the proposed example contains a reception of the information on the positions of the user equipment P0 . . . Pn drawn from the user equipment UE itself. Thus, the method according to the invention is triggered at the initiative of the user equipment UE.

As an alternative embodiment, the anticipation of the coverage discontinuity can be done and can also start on the initiative of the network. To illustrate this case, the initial request for determining the service discontinuity may come from a PS server, for “Public Safety”, outside the 4G/5G core network. Such servers have in fact need to verify whether a user equipment UE will always be available for a communication or to identify the cause of the loss of communication in progress with the user equipment UE of the end user. If the communication is lost due to a natural disaster, the server PS can thus initiate an alert and identify, as much as possible, the last known position of the user equipment UE for a rescue mission for example.

In this case where the method is triggered at the initiative of the network, the access and mobility management function AMF/MME takes the initiative to inform the user equipment UE with availability information CI relating to the coverage zone(s) and the out-of-coverage zone(s), these zones being defined with points and a zone type which can be a surface, a volume or a trajectory, or quite simply points of interest/sampling. In this hypothesis, the network function AMF pushes the coverage information CI in the NAS layer to the user equipment UE supporting the function. It is noted here that it is also possible to provide information on the coverage for any type of RAT having dynamic coverage, and not only for NG-RAN satellite systems.

In a secondary embodiment, only valid for 5G, the network function AMF may also receive the above elements relating to the positions of the user equipment UE via alternative channels, in the case where the user equipment UE does not provide them, namely via the network function NWDAF (for “Network Data Analytics Function”) or from an external server to the core network, via the network function NEF (Network Exposure Function).

In the embodiments presented above, the availability information is provided to the user equipment by the access management and mobility function in a registration acceptance message REG_Acc (“REGISTER ACCEPT”) or configuration update message UE_CONF_UD (“UE CONFIGURATION UPDATE” or UCU for short). These elements comprise a set of positions corresponding to a oversampling of the trajectory or of the zone, each of these positions having at least one dated event, for example via an absolute GNSS time, e.g.: GPS time, associated with a change of coverage state, for the entire required period of study.

For each of these events, information elements enabling the unique identification of the beam in the system are advantageously associated. In particular, the type of satellite among the LEO, MEO, GEO, and other systems, an identifier of the radio cell and a beam index are information useful to the user equipment UE. The generation of these availability information is detailed hereinafter.

FIG. 4 shows several satellite footprints S1, S2, S3 and S4. These footprints are calculated with the coordinates defining the position of the satellite, the angles, i.e. elevation E, azimuth A, defining the orientation of the beam BO and the beam aperture angle.

Referring to FIG. 2, a service for providing availability data CMS is accessible to the access and mobility management function AMF. This service has access to the coverage data as defined in FIG. 4. These data are known to the service for providing availability information CMS which actually collects elements provided by the control center SNCC of the satellite system, namely ephemerides describing the trajectories of the various satellites, parameters for identifying the beams, generally an identifier of the radio cell and a beam index, parameters for characterizing the beams, in particular size and orientation. This service also collects elements provided by an operations center and maintenance of the communication system, or a map of the tracking areas, an operating state of the beams, in particular whether the beam is functional or not. Advantageously, the control center SNCC also receives operations and maintenance information of an entity of the network 5G, which proceeds with the operations and maintenance of the satellite system and provides them to the service. Optionally, coverage availabilities other than satellite coverage but accessible by communications defined in the 5G standard are also accessible to the service for providing availability data.

It is noted here that these features for collecting information relating to satellite mobility are not at the heart of the invention, which in fact qualifies the type of the communication between the user equipment and the core network as well as the preferential type of the availability information by using coverage change events on an oversampling of a zone defining the possible positions of the user equipment for a given duration.

In FIG. 4, a set of four points P0 to P3 qualifies a trajectory of the user equipment UE. It should be noted that the four points shown in FIG. 4 can, in another context, describe a polygonal zone wherein the user equipment UE is expected for the duration defined elsewhere.

FIG. 5 thus shows an oversampling of a polygonal zone defined by four points P0 to P3. The step P as defined in the request for providing availability information makes it possible to define the grid defining the sampling points Q0 to Q4 within the polygon defined by the points P0 to P3. Thus, an oversampling is obtained inside the zone via a mesh of points spaced into X and Y of the value of the step P. It is noted here that a three-dimensional mesh can also be defined for the implementation of the invention.

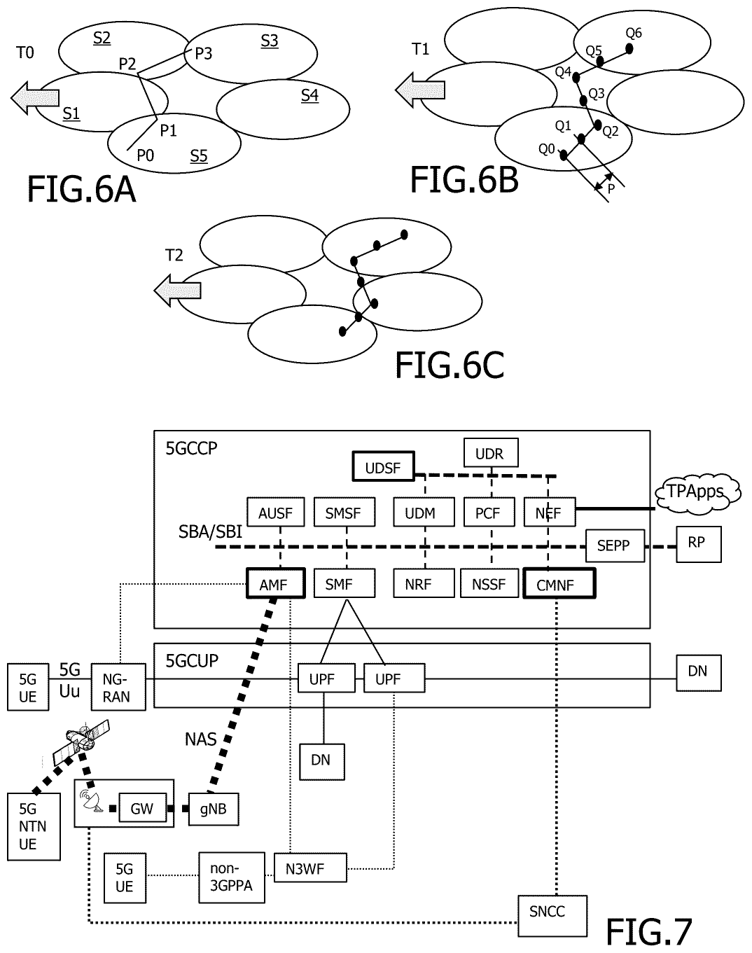

FIG. 6A to 6C give an example of generating the availability information CI. This example is proposed in a case where the zone type Z is a trajectory defined by points P0 to P3 as shown in FIG. 6A. The produced availability information CI will be returned by the access and mobility management function AMF in the NAS layer. This information CI describes a coverage gap according to an advantageous characteristic where only events are reported to the user equipment UE. This makes it possible to streamline the signaling in the NAS layer used according to the invention.

FIG. 6A therefore shows a set of four points P0 to P3 defining, this time, a trajectory. This trajectory is shown at an instant T0 where the entire trajectory is within coverage. Satellite footprints S1 to S5 are schematically shown. These footprints are mobile as symbolized by the thick gray arrow in FIG. 6A to 6C.

The user equipment UE knows its current position P0, according to a universal coordinate system which makes it possible to locate it uniquely on the surface of the globe. It should be noted that since a GNSS receiver is necessary for the user equipment NTN UE for the “timing advance” and Doppler compensation enabling synchronization in the uplink direction, this assumption is inherent to the system. The GNSS will also allow the user equipment to have an absolute dating source. However, it is noted here that the invention is particularly interesting in this context, but that it may also address cases where the user equipment is constrained and does not have a GNSS receiver and does not have access to its position or only does in a degraded manner. In particular, the implementation according to which the availability data are pushed to the user equipment can address these cases. This potentially relates to future releases of 3GPP standards, which must study the feasibility of deleting GNSS information so that the UE can connect to the satellite network

In the proposed example, however, the user equipment UE knows a set of positions {P1, P2, P3, . . . , Pn} which either directly give information about its future trajectory, or which delimit a zone (polyhedron or polygon) wherein the user equipment UE will be able to move.

Also, at T=T0, the user equipment UE provides its current position P0 and the future points of its trajectory or its movement zone P1, P2, P3 in a NAS request, for example a registration request. Advantageously there is added a step/over-sampling distance P, a period of study D and an indication of the type of shape Z, trajectory or movement zone.

If the user equipment UE knows its future trajectory, it will indicate the type of shape Z=trajectory. In this case, the network function AMF/MME will define sampled points {Q0, Q1, . . . , Q6} away from the step P along this trajectory, as shown in FIG. 6B.

If the user equipment UE only knows a possible movement zone, the provided list of points defines a polygon or polyhedron and the AMF/MME network function over-samples two-dimensional points inside the polygon or three-dimensional points inside the polyhedron, taking into account the sampling distance P on two axes (for example X, Y), as shown in FIG. 5.

Thus, when it receives the request, the network function AMF/MME contacts a server/service to obtain the current coverage information and the expected coverage information for the period of study regarding the list of oversampled points {Q0, . . . , Qn}.

The access management and mobility function will then interface with a service providing availability data to determine for the set of over-sampled positions, in the example the points Q0 to Q6 of the trajectory, and retrieving for each of these points a list defining the changes in the coverage of these over-sampled positions Q0 to Q6.

In the scenario shown in FIGS. 6A to 6C, at T=T0, the situation is such that all the sampled positions {Q0, Q1, Q2, Q3, Q5, Q6} are under LEO coverage. At T=T1 shown in FIG. 6B, it is provided that Q3 and Q4 will lose the LEO coverage, which was provided by, respectively, the identified cells S1 and S2. At T=T2 (with T2 less than the period of study D) shown in FIG. 6C, it is provided that Q4 regains an LEO coverage, with the cell identifier S3.

Thus, advantageously, only the points of the zone or of the trajectory where the state of the coverage has changed from among the anticipated over-sampled positions of the user equipment that were associated with a time element in order to qualify the change are retrieved.

The AMF/MME network function will then transmit in return to the user equipment UE the previously determined elements in a NAS message in response, for example a registration acceptance message REG_Acc or a UE_CONF_UD configuration update message in 5G as shown in FIG. 3. The availability information of the coverage returned to the user equipment UE in a NAS downlink message will then be as follows, as an event list:
Q0 (POS=LAT, LONG, ALT); GNSS time=T0; EVENT TYPE=COVERAGE LEO; ID CELL=S5
Q1 (POS=LAT, LONG, ALT); GNSS time=T0; EVENT TYPE=COVERAGE LEO; CELL ID=S5
Q2 (POS=LAT, LONG, ALT); GNSS time=T0; EVENT TYPE=COVERAGE LEO; ID CELL=S5
Q3 (POS=LAT, LONG, ALT); GNSS time=T0; EVENT TYPE=COVERAGE LEO; CELL ID=S1
Q4 (POS=LAT, LONG, ALT); GNSS time=T0; EVENT TYPE=COVERAGE LEO; ID CELL=S1
Q5 (POS=LAT, LONG, ALT); GNSS time=T0; EVENT TYPE=COVERAGE LEO; CELL ID=S2
Q6 (POS=LAT, LONG, ALT); GNSS time=T0; EVENT TYPE=COVERAGE LEO; CELL ID=S3
Q3 (POS=LAT, LONG, ALT); GNSS time=T1; EVENT TYPE=NO_COVERAGE LEO; CELL ID=S1
Q4 (POS=LAT, LONG, ALT); GNSS time=T1; EVENT TYPE=NO_COVERAGE LEO; CELL ID=S1
Q4 (POS=LAT, LONG, ALT); GNSS time=T2; EVENT TYPE=COVERAGE LEO; CELL ID=S3

It is noted here that only two event types are used: Presence of coverage and absence of coverage. The cell changes do not give rise to a specific event in this example, which makes it possible to reduce the quantity of data transmitted and to rely on the user equipment in order to itself proceed with the cell change.

It is also not indicated whether it is, in the case of a coverage presence, coverage regain, or, in the case of an absence of coverage, a coverage loss. However, it remains possible to add “loss” and “regain” events in addition to the two mentioned above. However, this increases the size of the availability data to be transmitted.

The functional description as well as the content of the previous NAS messages are updated in the specifications TS 23.501/502 and 24.501 (TS 23.401/402 and TS 24.301) to reflect the previous trajectory elements and coverage while complying with the requirements of the NAS protocols.

In the 5G case, as seen above, the AMF (“Access and Mobility Function”) network function may also optionally have subscribed to another service function in order to be notified of changes in the coverage characteristics along the trajectory or in the delimited zone. In this configuration and in the event of an effective change of characteristics received by the access management and mobility function AMF, that function will be able to send those new characteristics to the user equipment UE by using the configuration message of the user equipment UE_CONF_UD, for as long as the user equipment UE remains registered with the network.

The invention also optionally provides, in the case of the 5GS standard, for defining and integrating a new coverage management network function, in particular to manage coverage maps in the SBA/SBI 5GC architecture (SBA for “Service-Based Architecture” and SBI for “Service-Based Interface”). This makes it possible to take advantage of this architecture and to normalize the definition of the AMF Interface by means of new NF APIs (API for “Application Programming Interface” and NF for “Network Function”): Ncmnf_communication and Ncmnf_EventExposure.

Thus, in the preferred embodiment shown in FIG. 7, a service in charge of defining and managing coverage zones is integrated into the SBA architecture. A network function for managing coverage CMNF “Coverage Map Management Network Function” as described in patent application EP22305714 is then integrated into the control plane of the core network 5GCCP.

In the preferred embodiment combining the present invention and that described in application No. 22305714, the network function AMF can thus subscribe to the CMNF to be notified by the CMNF of any changes in coverage elements for the trajectory. If necessary, the network function AMF will send a new configuration update message UE_ID-UD to the user equipment UE with the new elements relating to the coverage.

It is noted here that the availability information as described and claimed in the invention has been produced by the CMNF defined in the application EP22305714 incorporated by reference. Also, the availability information as described in this preceding application can also constitute availability information that can be communicated via the NAS layer to the user equipment. The two kinds of availability data are foreseeable for the implementation of the invention. It is also noted here that other kinds of availability data of the point map type could also be communicated via a NAS protocol as claimed. However, this requires an increase in the quantities of data to be transmitted in comparison with a list of events according to the invention.

With this preferred embodiment, the access and mobility management function AMF requests a list of coverage events from the CMNF, by providing in the request the parameters received from the user equipment UE in the NAS message, or alternatively the parameters received from an external application function AF (“Application Function”) via the network function NEF or received from the network function NWDAF. In response, the CMNF network function provides a list of coverage events, and the network function AMF returns the list of events to the user equipment UE in a downlink NAS message.

The network function AMF may also subscribe to any change in the coverage information for a trajectory or a set of movement zone parameters. In this mode, the CMNF network function periodically reevaluates the coverage for the over-sampled positions and manages the list of events during the period of study, generating a notification with a new list if new events are provided or occur during the period. In this case, the network function AMF receives the notification from the CMNF and generates an update message for the configuration of the user equipment UE with the updated list of events, which is then sent to the user equipment UE.

In the detailed description above, reference is made to the appended drawings which show specific embodiments wherein the invention can be implemented. These embodiments are described in a sufficiently detailed manner to allow a person skilled in the art to put the invention into practice. The detailed description above should therefore not be taken in a limiting sense, and the scope of the present invention is defined only by the appended claims, interpreted appropriately.

1. A method for transmitting dynamic coverage availability information between a core network, comprising an access and mobility management function and collaborative with an access network having dynamic coverage, and a user equipment able to connect to the access network, the method comprising the following steps, for the access and mobility management function:
receiving a set of points characterizing anticipated positions of the user equipment,
retrieving dynamic coverage availability information for at least one point belonging to the anticipated positions of the user equipment,
sending to the user equipment a signaling message, in the Non-Access Stratum NAS layer, comprising the retrieved dynamic coverage availability information.

2. The method according to claim 1, wherein the dynamic coverage availability information comprises events related to dynamic coverage, an event being qualified by an event type, a time stamp, and coordinates of a point of the anticipated positions of the user equipment.

3. The method according to claim 2, wherein the event type is an absence of coverage or a presence of coverage.

4. The method according to one of the preceding claims, wherein a time window for studying the availability of the dynamic coverage being defined, the events related to the availability of the dynamic coverage have a time stamp included in the study time window.

5. The method according to one of the preceding claims, wherein, a sampling step of the anticipated positions of the user equipment being defined, the dynamic coverage availability information is limited to points thus sampled.

6. The method according to one of the preceding claims, wherein a zone type is associated with the set of points characterizing anticipated positions of the user equipment, the zone then defined by the set of points that can be of the trajectory type or of the polygon type or of the polyhedron type within which the user equipment is likely to move.

7. The method according to one of the preceding claims, wherein the dynamic coverage availability information is retrieved from a service for providing centralized dynamic coverage availability information associated with the core network.

8. The method according to claim 7, wherein the service for providing centralized dynamic coverage availability information is integrated into the core network as a network function according to a service architecture.

9. The method according to one of the preceding claims, wherein the set of points is received from the user equipment, which is able to determine its position and future positions.

10. The method according to one of claims 1 to 8, wherein the set of points is received from a management entity of the network having access to the position of the user equipment and to the anticipated positions.

11. The method according to one of the preceding claims, the method comprising steps of:
registering the user equipment with an update service for the dynamic coverage availability information,
automatically sending updated dynamic coverage availability information to the user equipment in a signaling message in the NAS layer.

12. An access and mobility management function integrated into a core network collaborating with an access network having dynamic coverage, the access and mobility management function comprising a communication interface configured to communicate with a user equipment able to connect to the access network,
the access and mobility management function being configured to carry out a method according to one of the preceding claims, and in order to do so, configured for:
receiving a set of points characterizing anticipated positions of the user equipment,
retrieving dynamic coverage availability information for at least one point belonging to the anticipated positions of the user equipment,
sending to the user equipment a signaling message, in the NAS layer, comprising the retrieved dynamic coverage availability information.

13. A core network comprising an access and mobility management function according to claim 12.

14. The core network according to claim 13, characterized in that a service for providing dynamic coverage availability information is integrated into the core network as a network function according to a service architecture.

15. A user equipment able to connect to an access management and mobility management function according to claim 13 or 14 via an access network having dynamic coverage, the user equipment further having access to a geolocation device for determining its geographical position, the user equipment being configured for:
receiving, from the access and mobility management function, a signaling message in the NAS layer comprising dynamic coverage availability information,
managing connections to the access network based on the received dynamic coverage availability information and the geographical position of the user equipment.

16. The user equipment according to claim 15, configured for:
determining a set of points characterizing anticipated positions of the user equipment,
sending, to the access and mobility management function, a message in the NAS layer including the set of points thus determined to allow it to retrieve the availability information.
